(19) United States
(12) Patent Application Publication
(10) Pub. No.: US 2013/0089744 A1
(43) Pub. Date: Apr. 11, 2013

(54) Chemically-welded optical devices

(71) Applicant: RealD Inc., Beverly Hills, CA (US)

(72) Inventors: Douglas K. McKnight, Boulder, CO (US); Michael G. Robinson, Boulder, CO (US); Robert A. Ramsey, Loveland, CO (US)

(73) Assignee: REALD INC., Beverly Hills, CA (US)

(21) Appl. No.: 13/646,472

(22) Filed: Oct. 5, 2012

Related U.S. Application Data
(60) Provisional application No. 61/543,777, filed on Oct. 5, 2011.

(51) Int. Cl. B32B 7/10; B32B 37/00

(52) U.S. Cl. CPC B32B 7/10; B32B 37/0038
USPC 428/420; 156/308.6; 156/60

(57) ABSTRACT

Chemically-welded optical devices and associated methods for chemically welding optical devices are disclosed herein. Such optical devices may be used in display systems, and may include subcomponents comprising one or more optical films employed for polarization manipulation, as well as a substrate for protecting the optical film(s). An optical film may be chemically welded directly to the substrate using a solvent, and any additional optical films may be chemically welded to a prior optical film previously welded to the substrate. The chemical welding process of the present disclosure may include applying the solvent on the optical film in order to partially dissolve the surface of the optical film prior to adhesion to the substrate. Macromolecules on the dissolved surface of the optical film may be in a loosened state and may be realigned when the solvent evaporates.

### PRIORITY CLAIM

This disclosure is a nonprovisional conversion of, and thus claims priority to, U.S. Provisional Patent Application No. 61/543777, entitled “Chemically-welded optical devices” and filed on Oct. 5, 2011, which is incorporated by reference herein.

### TECHNICAL FIELD

This disclosure generally relates to optical devices and, more particularly, relates to optical devices having chemically welded subcomponents.

### BACKGROUND

Adhesives, such as pressure-sensitive adhesives (PSA), have been widely used for joining objects made of dissimilar materials. PSAs form a bond by the application of light pressure to join the adhesive with the adherend. Applications of PSA include laminating subcomponents of optical devices into a permanent or removable composite structure.

### SUMMARY

In accordance with the disclosed principles, chemically-welded optical devices and associated methods for chemically welding optical devices are disclosed herein. Such optical devices may be used in display systems, and may include subcomponents comprising one or more optical films employed for polarization manipulation, as well as a substrate for protecting the optical film(s). An optical film may be chemically welded directly to the substrate using a solvent, and any additional optical films may be chemically welded to a prior optical film previously welded to the substrate. The chemical welding process of the present disclosure may include applying the solvent on the optical film in order to partially dissolve the surface of the optical film prior to adhesion to the substrate. Macromolecules on the dissolved surface of the optical film may be in a loosened state and may be realigned when the solvent evaporates.

In one exemplary embodiment, an optical device for use with a display system is provided. Such an optical device may comprise an optical film and a substrate operable to protect the film. Additionally in such embodiments, a contact surface of the film is chemically welded to a contact surface of the substrate by loosened macromolecules of the contact surface of the film achieving critical entanglement with microstructures on the contact surface of the substrate. As mentioned above, the optical film may be a polymer film, and the substrate may be a glass substrate. In more specific embodiments, the macromolecules of the contact surface of the film are loosened using a solvent disposed on the contact surface of the film, the solvent operable to temporarily dissolve macromolecules on the contact surface of the film contacting the contact surface of the substrate. Advantageously, the solvent may be selected based on a desired amount of penetration of the contact surface of the film.

In further embodiments, an adhesion promoter may be disposed on the surface of the substrate, the adhesion promoter bonding with at least a portion of the contact surface of the substrate and at least a portion of the macromolecules on the contact surface of the film to increase adhesion strength between the contact surfaces of the film and the substrate. Moreover, a second optical film may also be included in the optical device. In such embodiments, a contact surface of the second film is chemically welded to a second contact surface of the first film, which is opposite the first contact surface, by loosened macromolecules of the contact surface of the second film achieving critical entanglement with microstructures on the second contact surface of the first film.

In other aspects, methods of chemically welding an optical device for use with a display system are also disclosed herein. In an exemplary embodiment, such a method may comprise providing an optical film and a substrate operable to protect the film, and disposing a solvent on a contact surface of the film. The solvent may be used to temporarily dissolve macromolecules on the contact surface of the film. Such methods may then comprise positioning the contact surface of the film against a contact surface of the substrate, wherein loosened macromolecules on the contact surface of the film achieve critical entanglement with microstructures on the contact surface of the substrate thereby chemically welding the film to the substrate. Moreover, variations and additions to such exemplary methods in accordance with the examples discussed above may also be performed when performing chemical welding in accordance with the disclosed principles.

### BRIEF DESCRIPTION OF THE DRAWINGS

FIG. 1 is a schematic diagram of the side view of an optical device;

FIG. 2A is a schematic diagram of the side view of a chemically-welded optical device, in accordance with the present disclosure;

FIG. 2B is a schematic diagram of the perspective side view of the chemically-welded optical device shown in FIG. 2A, in accordance with the present disclosure;

FIG. 3 is a flow chart of the method for chemically welding subcomponents of an optical device, in accordance with the present disclosure; and

FIG. 4 is a schematic diagram of the perspective side view of a chemically-welded optical device with a stack having more than one polymer layers, in accordance with the present disclosure.

### DETAILED DESCRIPTION

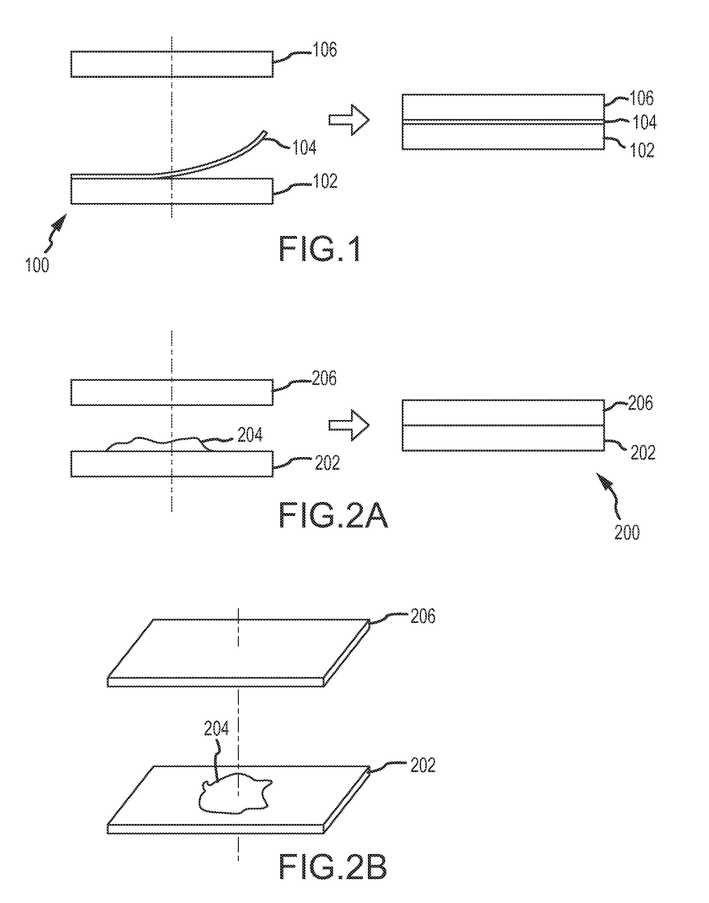

FIG. 1 is a schematic diagram of a side view of an optical device 100 for use, for example, in visual display systems. Specifically, the right side of FIG. 1 illustrates an assembled optical device 100, while the left side of FIG. 1 illustrates an exploded view of the optical device 100. The optical device 100 may comprise a polymer film 102 that may perform various roles in a display system or a projection system, depending on the optical properties of the polymer film 102. For example, retarders and polarizers made from a variety of polymer films 102 may be used in optical systems, such as a stereoscopic, or 3D, system or a projection system. The optical device 100 may include one or more polymer films 102 attached to a glass substrate 106 for structural support and protection from the surrounding environment.

One approach for attaching the polymer film 102 to the glass substrate 106 may be through lamination with a pressure sensitive adhesive (PSA) 104. PSAs 104 generally have good tackiness and enough adhesive strength for laminating the polymer film 102 to the glass substrate 106. While lamination with a PSA 104 may be acceptable in some applications, the price of the PSA 104 may be cost prohibitive in some instances. Further, the lamination process with the PSA 104 is done on a sheet-by-sheet basis, and thus may result in a bottle-neck during the assembly process, thereby resulting in lower yields. As such, there is a need in the art for an inexpensive approach for attaching a polymer film to a glass substrate. There is also a need for a novel approach that may result in a higher yield process.

FIG. 2A is a schematic diagram of a side view of a chemically-welded optical device 200 constructed in accordance with the disclosed principles. As with FIG. 1, the right side of FIG. 2 illustrates an assembled optical device 200, while the left side of FIG. 2 illustrates an exploded view of the optical device 200. FIG. 2B is a schematic diagram of the perspective side view of the chemically-welded optical device 200 shown in FIG. 2A. The optical device 200 may be used in display systems, and may include subcomponents comprising a polymer film 202, a solvent 204, and a glass substrate 206. In one exemplary embodiment in accordance with the present disclosure, one or more polymer films 202 may be chemically welded to the glass substrate 206 directly with the solvent 204. In view of the disclosed embodiment, one of ordinary skill in the art would appreciate that one benefit of using chemical welding may be the elimination of an adhesive layer between the polymer film 202 and the glass substrate 206, thereby reducing material costs.

The chemical welding process of the present disclosure may include applying the solvent 204 on the polymer film 202 as illustrated in FIG. 2A and FIG. 2B in order to partially dissolve the surface of the polymer film 202 prior to adhesion to the glass substrate 206. Macromolecules on the dissolved surface of the polymer film 202 may be in a loosened state and may be realigned when the solvent 204 evaporates. The polymer film 202 and the glass substrate 206 may be brought together before the solvent 204 evaporates to allow direct contact between the glass substrate 206 and the macromolecules on the dissolved surface of the polymer film 202. Due to their dissolved state, the surface macromolecules of the polymer film 202 infiltrate and achieve critical entanglement to the microstructure of the surface of the glass substrate 206. As the solvent 204 disperses through the film and ultimately evaporates, the free monomers entangled in the microscopic surface roughness of the glass substrate 206 may form direct chemical and/or physical bonds with the surface of the glass substrate 206, which allows for appreciable adhesion of the polymer film 202 with the glass substrate 206.

As such, one factor that may affect the strength of the adhesion may be the amount of microscopic surface roughness of the glass substrate 206. Other factors may affect the bonding (welding) of polymer-based materials to glass, including surface energies, and to a lesser extent local molecular forces.

In some embodiments, the adhesive strength between the polymer film 202 and the glass substrate 206 may be improved by pre-treating the glass surface 206 with an adhesion promoter (not shown). Suitable adhesion promoters may include silanes, hexamethyldisilazane (HMDS), or any other adhesion promoter known in the art. In an embodiment, the pre-treatment may include a wash of the adhesion promoter, which may have a good affinity to both the glass substrate 206 and the polymer film 202 that may be chemically welded. By pre-treating the glass substrate 206 with a wash of the adhesion promoter, the adhesion promoter may be distributed on and bond with the surface of the glass substrate 206 while leaving enough free bonds for bonding with the dissolved surface macromolecules of the polymer film 202. The additional bonding between the adhesion promoter and the polymer film 202 may allow for enhanced adhesion strength between the polymer film 202 and the glass substrate 206.

The choice of a suitable solvent 204 for the embodiments of the present disclosure may be made with consideration of a range of factors. In an embodiment, it may be desirable to choose a solvent that allows for a good range of index matching between the glass substrate 206 and the polymer substrate 202. In an exemplary embodiment, it may also be desirable to choose a solvent 204 that may be strong enough to penetrate the polymer film 202 and dissolve the desired amount of surface macromolecules, but not too strong so as to damage the desired optical properties of the polymer film 202. Some suitable combinations of polymer films 202 and solvents 204 for chemical welding are described in U.S. patent application Ser. No. 12/032,555, which is commonly-owned with the present disclosure and hereby incorporated by reference in its entirety. It should be mentioned, however, that the specific solvents 204 for chemically welding various polymer films 202 to glass substrates 206 may differ based on the specific embodiment.

In some embodiments, the adhesive strength between the polymer film 202 and the glass substrate 206 may be improved by pre-treating the glass surface 206 with an adhesion promoter (not shown). Suitable adhesion promoters may include silanes, hexamethyldisilazane (HMDS), or any other adhesion promoter known in the art, either now existing or later developed. In an exemplary embodiment, the pre-treatment may include a wash of the adhesion promoter, which may have a good affinity to both the glass substrate 206 and the polymer film 202 that may be chemically welded. By pre-treating the glass substrate 206 with a wash of the adhesion promoter, the adhesion promoter may be distributed on and bond with the surface of the glass substrate 206, while leaving enough free bonds for bonding with the dissolved surface macromolecules of the polymer film 202. The additional bonding between the adhesion promoter and the polymer film 202 may allow for enhanced adhesion strength between the polymer film 202 and the glass substrate 206.

In an embodiment, a desired adhesion may be achieve by sufficient intermingling of polymer chains to glass. For example, the more the chains are intermingled, the harder it is to pull them apart when stress is applied. It is to be understood that strong adhesion may be achieved if the polymers to be bonded to glass are above a “critical entanglement limit” as mentioned above. To get polymer chains to entangle, they are to be thermodynamically more stable when extended as opposed to closed in upon themselves. For example, if two identical polymer surfaces are mixed, they will readily entangle as long as there is a kinetic initiation. In an embodiment, the effects of this kinetic ignition may be dependent on the solubility of a solvent. Several models of polymer solution thermodynamics may be used to determined an optimized solubility and choose a suitable solvent. In an exemplary embodiment, the determination of optimized solubility and suitable may be based on the Hansen Solubility Parameters (HSP)—(δD, δP and δH). These three parameters, δD, δP and δH, deal with molecular dispersion forces, polar forces and hydrogen bonding forces for materials, respectively. They are empirical numbers based on experimental techniques. All polymers and solvents have HSP values. Good solubility of a solvent to dissolve a polymer may be achieved in an exemplary embodiment by using a solvent with HSP that closely match that of the polymer. For example, the material Cyclo-Olefin Polymer has the HSP as listed in Table 1 along with exemplary solvents which are closely matched. An approach for bonding of multiple materials, such as a polymer film and surface prepared glass, is to utilize a mixture of a plurality of solvents to obtain the best HSP match for the materials combination. This again may be achieved experimentally. In an embodiment, once a match of the polymer HSP and the solvent HSP is determined, one may simulate several different scenarios such as, diffusion of solvent into polymer, distance of critical entanglement for polymer and contact time of solvent for a desired entanglement.

TABLE 1

| Material | δD | δP | δH |
|---|---|---|---|
| Cyclo-Olefin | 17.1 | 3.8 | 3.8 |
| Polymer | | | |
| Cyclpentyl | 16.7 | 4.3 | 4.3 |
| Methyl Ether | | | |
| (CPME) | | | |
| Chloroform | 17.2 | 3.1 | 4.7 |
| Xylene | 17.8 | 2 | 3.1 |
| Toluene | 17.9 | 1.4 | 2.1 |
| Sec-Butylbenzene | 16.8 | 43.1 | 4.2 |

Provided below are exemplary solvents suitable for bonding an exemplary polymeric material to a surface prepared glass substrate.

In an embodiment, if the polymer material to be bonded to a surface prepared glass is a Cyclo-Olefin Polymer based material, a suitable solvent according to the present disclosure may include Cyclpentyl Methyl Ether (CPME).

In an embodiment, if the polymer material to be bonded to a surface prepared glass is a Cyclo-Olefin Polymer based material, a suitable solvent according to the present disclosure may include Xylene.

In an embodiment, if the polymer material to be bonded to a surface prepared glass is a Cyclo-Olefin Polymer based material, a suitable solvent according to the present disclosure may include a solvent from the family of Aromatic Hydrocarbons.

In an embodiment, if the polymer material to be bonded to a surface prepared glass is a Cyclo-Olefin Polymer based material, a suitable solvent according to the present disclosure may include a solvent with Hansen Solubility Parameters of δD=17.1+1.0, δP=3.8+1.0 and δH=3.8+1.0.

In an embodiment, if the polymer material to be bonded to a surface prepared glass is a Cyclo-Olefin Polymer based material one would utilize a binary mixture of solvents who's Hansen Solubility Parameters results in δD=17.1+1.0, δP=3.8+1.0 and δH=3.8+1.0.

In an embodiment, if the polymer material to be bonded to a surface prepared glass is a Cyclo-Olefin Polymer based material one would utilize a ternary mixture of solvents who's Hansen Solubility Parameters results in δD=17.1+1.0, δP=3.8+1.0 and δH=3.8+1.0.

In an embodiment, if the polymer material to be bonded to a surface prepared glass is a Cyclo-Olefin Polymer based material, a suitable solvent according to the present disclosure may include Cyclpentyl Methyl Ether (CPME).

In an embodiment, if the polymer material to be bonded to a surface prepared glass is a Cyclo-Olefin Co-Polymer based material, a suitable solvent according to the present disclosure may include Toluene.

In an embodiment, if the polymer material to be bonded to a surface prepared glass is a Cyclo-Olefin Co-Polymer based material, a suitable solvent according to the present disclosure may include Cyclpentyl Methyl Ether (CPME).

In an embodiment, if the polymer material to be bonded to a surface prepared glass is a Cyclo-Olefin Co-Polymer based material, a suitable solvent according to the present disclosure may include in the family of Aromatic Hydrocarbons.

In an embodiment, if the polymer material to be bonded to a surface prepared glass is a Cyclo-Olefin Co-Polymer based material, a suitable solvent according to the present disclosure may include a solvent with Hansen Solubility Parameters of δD=18.0+1.0, δP=3.0+1.0 and δH=2.0+1.0

In an embodiment, if the polymer material to be bonded to a surface prepared glass is a Cyclo-Olefin Co-Polymer based material one would utilize a binary mixture of solvents who's Hansen Solubility Parameters results in δD=18.0+1.0, δP=3.0+1.0 and δH=2.0+1.0.

In an embodiment, if the polymer material to be bonded to a surface prepared glass is a Cyclo-Olefin Co-Polymer based material one would utilize a ternary mixture of solvents who's Hansen Solubility Parameters results in δD=18.0+1.0, δP=3.0+1.0 and δH=2.0+1.0.

In an embodiment, if the polymer material to be bonded to a surface prepared glass is a Polycarbonate (PC) based material, a suitable solvent according to the present disclosure may include N-Cyclohexyl-2-Pyrrolidone.

In an embodiment, if the polymer material to be bonded to a surface prepared glass is a Polycarbonate (PC) based material, a suitable solvent according to the present disclosure may include in the family of alkyl pyrrolidones.

In an embodiment, if the polymer material to be bonded to a surface prepared glass is a Polycarbonate (PC) based material, a suitable solvent according to the present disclosure may include a solvent with Hansen Solubility Parameters of δD=18.2+1.0, δP=5.9+1.0 and δH=6.9+1.0.

In an embodiment, if the polymer material to be bonded to a surface prepared glass is a Polycarbonate (PC) based material one would utilize a binary mixture of solvents who's Hansen Solubility Parameters results in δD=18.2+1.0, δP=5.9+1.0 and δH=6.9+1.0.

In an embodiment, if the polymer material to be bonded to a surface prepared glass is a Polycarbonate (PC) based material one would utilize a ternary mixture of solvents who's Hansen Solubility Parameters results in δD=18.2+1.0, δP=5.9+1.0 and δH=6.9+1.0.

In an embodiment, if the polymer material to be bonded to a surface prepared glass is a Cellulose Triacetate (TAC) based material, a suitable solvent according to the present disclosure may include N-Methyl Acetamide.

In an embodiment, if the polymer material to be bonded to a surface prepared glass is a Cellulose Triacetate (TAC) based material, a suitable solvent according to the present disclosure may include in the family of amide.

In an embodiment, if the polymer material to be bonded to a surface prepared glass is a Cellulose Triacetate (TAC) based material, a suitable solvent according to the present disclosure may include a solvent with Hansen Solubility Parameters of δD=18.3+1.0, δP=16.5+2.0 and δH=11.8+2.0.

In an embodiment, if the polymer material to be bonded to a surface prepared glass is a Cellulose Triacetate (TAC) based material one would utilize a binary mixture of solvents who's Hansen Solubility Parameters results in δD=18.3+1.0, δP=16.5+2.0 and δH=11.8+2.0.

In an embodiment, if the polymer material to be bonded to a surface prepared glass is a Cellulose Triacetate (TAC) based material one would utilize a ternary mixture of solvents who's Hansen Solubility Parameters results in δD=18.3+1.0, δP=16.5+2.0 and δH=11.8+2.0.

In an embodiment, if the polymer material to be bonded to a surface prepared glass is a Polyvinyl Alcohol (PVA) based material, a suitable solvent according to the present disclosure may include Nitric Acid.

In an embodiment, if the polymer material to be bonded to a surface prepared glass is a Polyvinyl Alcohol (PVA) based material, a suitable solvent according to the present disclosure may include in the family of inorganic acid.

In an embodiment, if the polymer material to be bonded to a surface prepared glass is a Polyvinyl Alcohol (PVA) based material, a suitable solvent according to the present disclosure may include a solvent with Hansen Solubility Parameters of δD=15.0+2.0, δP=17.2+2.0 and δH=17.8+2.0.

In an embodiment, if the polymer material to be bonded to a surface prepared glass is a Polyvinyl Alcohol (PVA) based material one would utilize a binary mixture of solvents who's Hansen Solubility Parameters results in δD=15.0+2.0, δP=17.2+2.0 and δH=17.8+2.0.

In an embodiment, if the polymer material to be bonded to a surface prepared glass is a Polyvinyl Alcohol (PVA) based material one would utilize a ternary mixture of solvents who's Hansen Solubility Parameters results in δD=15.0+2.0, δP=17.2+2.0 and δH=17.8+2.0.

In an embodiment, if the polymer material to be bonded to a surface prepared glass is a polyethylene terephthalate (PET) based material, a suitable solvent according to the present disclosure may include Benzyl Acetate.

In an embodiment, if the polymer material to be bonded to a surface prepared glass is a polyethylene terephthalate (PET) based material, a suitable solvent according to the present disclosure may include in the family of aromatic and aliphatic esters.

In an embodiment, if the polymer material to be bonded to a surface prepared glass is a polyethylene terephthalate (PET) based material, a suitable solvent according to the present disclosure may include a solvent with Hansen Solubility Parameters of δD=18.2+2.0, δP=6.4+3.0 and δH=6.6+3.0.

In an embodiment, if the polymer material to be bonded to a surface prepared glass is a polyethylene terephthalate (PET) based material, a suitable solvent according to the present disclosure may include a binary mixture of solvents whose Hansen Solubility Parameters results in δD=18.2+2.0, δP=6.4+3.0 and δH=6.6+3.0.

In an embodiment, if the polymer material to be bonded to a surface prepared glass is a polyethylene terephthalate (PET) based material a suitable solvent according to the present disclosure may include a ternary mixture of solvents whose Hansen Solubility Parameters results in δD=18.2+2.0, δP=6.4+3.0 and δH=6.6+3.0.

In an embodiment, if the polymer material to be bonded to a surface prepared glass is a poly-methylmethacrylate (PMAA) based material, a suitable solvent according to the present disclosure may include N-Methyl-2-Pyrrolidone.

In an embodiment, if the polymer material to be bonded to a surface prepared glass is a poly-methylmethacrylate (PMAA) based material, a suitable solvent according to the present disclosure may include in the family of cyclic amides.

In an embodiment, if the polymer material to be bonded to a surface prepared glass is a poly-methylmethacrylate (PMAA) based material, a suitable solvent according to the present disclosure may include a solvent with Hansen Solubility Parameters of δD=18.6+1.0, δP=10.5+2.0 and δH=7.2+2.0.

In an embodiment, if the polymer material to be bonded to a surface prepared glass is a poly-methylmethacrylate (PMAA) based material, a suitable solvent according to the present disclosure may include a binary mixture of solvents whose Hansen Solubility Parameters results in δD=18.6+1.0, δP=10.5+2.0 and δH=7.2+2.0.

In an embodiment, if the polymer material to be bonded to a surface prepared glass is a poly-methylmethacrylate (PMAA) based material, a suitable solvent according to the present disclosure may include a ternary mixture of solvents whose Hansen Solubility Parameters results in δD=18.6+1.0, δP=10.5+2.0 and δH=7.2+2.0.

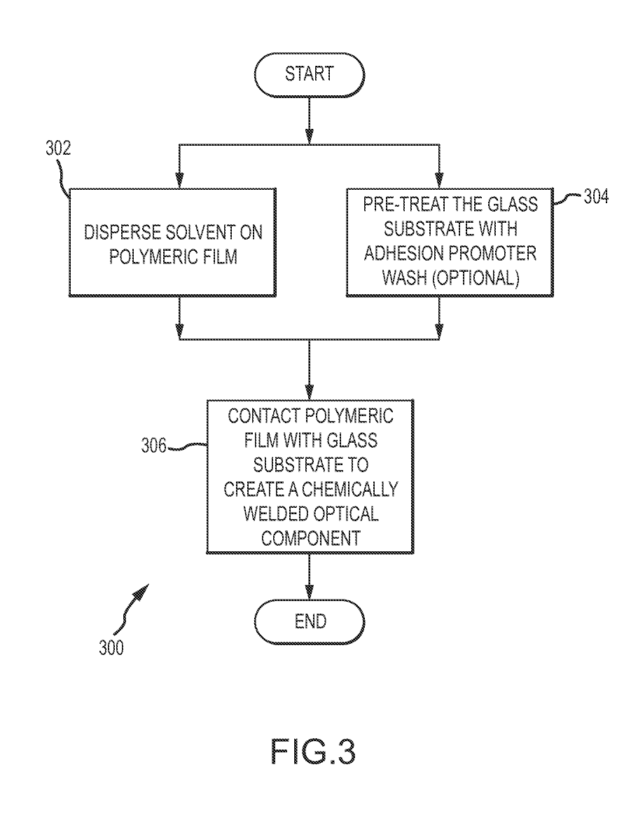

FIG. 3 is a flow chart of a method 300 for chemically welding subcomponents of an optical device, in accordance with the present disclosure. The process flow begins at a Start step where a decision is made whether to employ an adhesion promoter or not. At step 302, solvent may be dispensed on a polymer film to be bonded to a glass substrate. At step 304, a glass substrate may optionally be pre-treated with an adhesion promoter wash, as discussed above. Whether an adhesion promoter is employed or not, at step 306, the polymer film may be contacted with the glass substrate to create a chemically-welded bond between the polymer film and the glass substrate of the optical device. The process flow then ends at an End step.

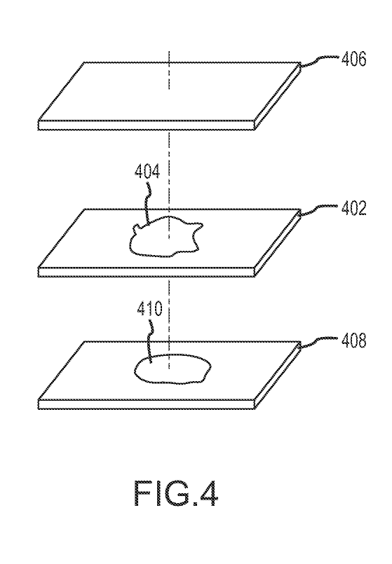

FIG. 4 is a schematic diagram of a perspective side view of an optical device 400 with a stack having more than one polymer film layer. Similar to the previously disclosed embodiments, in the exemplary embodiment illustrated in FIG. 4, the optical device 400 may include subcomponents comprising a first polymer film 402, a first solvent 404, and a glass substrate 406. The first solvent 404 may allow for chemical welding between the first polymer film 402 and the glass substrate 406, as discussed in detail above. Also as discussed above, an adhesion promoter may first be employed when bonding the first polymer film 402 to the glass substrate 406.

The optical device 400 in FIG. 4 may further include subcomponents comprising a second polymer film 408 and a second solvent 410. The second solvent 410 may allow for chemical welding between the second polymer film 408 and the first polymer film 402. Again, an adhesion promoter may first be employed when bonding the second polymer film 403 to the first polymer film 402. Also, the first solvent 404 and the second solvent 410 may comprise the same solvent or may comprise different solvents. More specifically, the first and second solvents may be selected based on the composition of the first and second polymer films, 402, 403, as well as the composition of the substrate 406. The first polymer film 402 and the second polymer film 408 may comprise the same polymer film, e.g., two retarders, or may comprise different polymer films, e.g. one retarder and one polarizer.

It is to be appreciated that the chemically welded structure of a polymer film and glass substrate may be included in a variety of optical devices for a variety of display and projection systems and subcomponents, which may include, but are not limited to, retarders, polarizers, filters, mirrors, and substrates, as taught in Polarization Engineering for LCD Projection by Michael G. Robinson et al., which is hereby incorporated by reference. Moreover, it should be appreciated that the principles disclosed herein may also be employed in chemically welding non-polymeric optical films, as well as bonding a variety of optical films to non-glass optical substrates.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical device for use with a display system, the optical device comprising:
an optical film; and
a substrate operable to protect the film;
wherein a contact surface of the film is chemically welded to a contact surface of the substrate by loosened macromolecules of the contact surface of the film achieving critical entanglement with microstructures on the contact surface of the substrate.

2. An optical device in accordance with claim 1, wherein the macromolecules of the contact surface of the film are loosened using a solvent disposed on the contact surface of the film, the solvent operable to temporarily dissolve macromolecules on the contact surface of the film contacting the contact surface of the substrate.

3. An optical device in accordance with claim 2, wherein the solvent is selected based on a desired amount of penetration of the contact surface of the film.

4. An optical device in accordance with claim 1, further comprising an adhesion promoter disposed on the surface of the substrate, the adhesion promoter bonding with at least a portion of the contact surface of the substrate and at least a portion of the macromolecules on the contact surface of the film to increase adhesion strength between the contact surfaces of the film and the substrate.

5. An optical device in accordance with claim 1, wherein the film is a polymer film.

6. An optical device in accordance with claim 1, wherein the substrate is a glass substrate.

7. An optical device in accordance with claim 1, further comprising a second optical film, wherein a contact surface of the second film is chemically welded to a second contact surface of the first film, which is opposite the first contact surface, by loosened macromolecules of the contact surface of the second film achieving critical entanglement with microstructures on the second contact surface of the first film.

8. An optical device in accordance with claim 7, wherein the contact surface of the second film is further chemically welded to the second contact surface of the first film by loosened macromolecules of the second contact surface of the first film achieving critical entanglement with microstructures and/or loosened macromolecules on the contact surface of the second film.

9. An optical device in accordance with claim 7, wherein the second optical film is a polymer film.

10. An optical device in accordance with claim 7, wherein the second solvent is selected based on a desired amount of penetration of the contact surface of the second film.

11. An optical device for use with a display system, the optical device comprising:
an optical polymer film; and
a glass substrate operable to protect the polymer film; and
a solvent disposed on the polymer film and the glass substrate, wherein a contact surface of the polymer film is chemically welded to a contact surface of the glass substrate by the solvent loosening macromolecules of the contact surface of the polymer film sufficient to achieve critical entanglement with microstructures on the contact surface of the glass substrate.

12. An optical device in accordance with claim 11, wherein the solvent is selected based on a desired amount of penetration of the contact surface of the film.

13. An optical device in accordance with claim 11, further comprising an adhesion promoter disposed on the contact surface of the substrate, the adhesion promoter bonding with at least a portion of the contact surface of the substrate and at least a portion of the macromolecules on the contact surface of the film to increase adhesion strength between the contact surfaces of the film and the substrate.

14. An optical device in accordance with claim 11, further comprising:
a second optical polymer film; and
a second solvent disposed between the first and second films, wherein a contact surface of the second film is chemically welded to a second contact surface of the first film, which is opposite the first contact surface, by the second solvent loosening macromolecules of the contact surface of the second film sufficient to achieve critical entanglement with microstructures on the second contact surface of the first film.

15. An optical device in accordance with claim 14, wherein the contact surface of the second film is further chemically welded to the second contact surface of the first film by loosened macromolecules of the second contact surface of the first film achieving critical entanglement with microstructures and/or loosened macromolecules on the contact surface of the second film.

16. An optical device in accordance with claim 14, wherein the second optical film is a polymer film.

17. An optical device in accordance with claim 14, wherein the second solvent is selected based on a desired amount of penetration of the contact surface of the second film.

18. A method of chemically welding an optical device for use with a display system, the method comprising:
providing an optical film and a substrate operable to protect the film;
disposing a solvent on a contact surface of the film, the solvent temporarily dissolving macromolecules on the contact surface of the film; and
positioning the contact surface of the film against a contact surface of the substrate, wherein loosened macromolecules on the contact surface of the film achieve critical entanglement with microstructures on the contact surface of the substrate thereby chemically welding the film to the substrate.

19. A method in accordance with claim 18, further comprising selecting the solvent based on a desired amount of penetration of the contact surface of the film.

20. A method in accordance with claim 18, further comprising disposing an adhesion promoter on the contact surface of the substrate prior to positioning the contact surface of the film against the contact surface of the substrate, the adhesion promoter bonding with at least a portion of the contact surface of the substrate and at least a portion of the macromolecules on the contact surface of the film to increase adhesion strength between the contact surfaces of the film and the substrate.

21. A method in accordance with claim 18, wherein the film is a polymer film.

22. A method in accordance with claim 18, wherein the substrate is a glass substrate.

23. A method in accordance with claim 18, further comprising:
providing a second optical film;
disposing a second solvent on a contact surface of the second film, the solvent temporarily dissolving macromolecules on the contact surface of the second film; and
positioning the contact surface of the second film against a second contact surface of the first film, which is opposite the first contact surface, wherein loosened macromolecules on the contact surface of the second film achieve critical entanglement with microstructures on the second contact surface of the first film thereby chemically welding the second film to the first film.

24. A method in accordance with claim 23, wherein the contact surface of the second film is further chemically welded to the second contact surface of the first film by loosened macromolecules of the second contact surface of the first film achieving critical entanglement with microstructures and/or loosened macromolecules on the contact surface of the second film.

25. An optical device in accordance with claim 23, wherein the second optical film is a polymer film.

26. A method in accordance with claim 23, further comprising selecting the second solvent based on a desired amount of penetration of the contact surface of the second film.
